(19) United States
(12) Patent Application Publication
(10) Pub. No.: US 2015/0066526 A1
(43) Pub. Date: Mar. 5, 2015

(54) Exercise Management Service Method and System Thereof

(71) Applicant: Wistron Corporation, New Taipei City (TW)

(72) Inventors: Shou-Yi Cheng, New Taipei City (TW); Hong-Zong Lin, New Taipei City (TW); Chen Yang, New Taipei City (TW); Jung-Ying Yi, New Taipei City (TW)

(73) Assignee: Wistron Corporation, New Taipei City (TW)

(21) Appl. No.: 14/187,342

(22) Filed: Feb. 24, 2014

(30) Foreign Application Priority Data
Sep. 4, 2013 (TW) 102131861

(51) Int. Cl. G06F 19/00

(52) U.S. Cl. CPC G06F 19/3481
USPC 705/2

(57) ABSTRACT

A method of providing exercise management service for a sports center, wherein the sports center includes an exercise management service system, an exercise recording device and at least one exercise equipment. The method includes establishing a personal database by the exercise management service system, establishing an exercise record by the exercise recording device, transmitting the exercise record to the exercise management service system by the exercise recording device, and generating an exercise prescription according to the personal database and the exercise record by the exercise management service system.

### BACKGROUND OF THE INVENTION

1. Field of the Invention

The present invention relates to an exercise management service method and system thereof, and more particularly to an exercise management service method and system thereof for providing electronic recording and management services.

2. Description of the Prior Art

Management and services for running a gymnasium or sports center are mostly operated by manpower. For example, regarding a membership management, personal information, renting and expenditure records of a member are written onto paper by a staff in the sports center. And an exercise record of the member, which includes information such as a type of exercise, a movement, a weight of stacks, a number of repetition, a number of sets and a duration, is also written onto paper. However, there may be recording errors on the paper due to human errors, and such routine recording work also waste manpower of the sports center.

Regarding equipment management, a life time and a maintenance schedule (e.g. every six months) are recorded onto paper or marked on the equipment, which are checked by the staff to perform maintenance to the equipment accordingly. However, numbers of actually used hours and times of the equipment are unknown, making it difficult to check know whether the equipment is overused or not.

On the other hand, a coach or trainer may not always be available to accompany with the member at all times due to limited manpower. Sports injuries may happen without an instruction of the trainer. For example, if the member performs intensive exercise without warming up first, or the member does not have sufficient rest during the exercise, a risk of sports injuries rises.

Therefore, there is a need to provide an exercise management service method and system thereof to provide electronic recording and management services to solve the above problems.

### SUMMARY OF THE INVENTION

It is therefore an objective of the present invention to provide electronic recording and management services to solve the above problems.

The present invention discloses a method of providing exercise management service for a sports center, wherein the sports center includes an exercise management service system, an exercise recording device and at least one exercise equipment. The method includes establishing a personal database by the exercise management service system, establishing an exercise record by the exercise recording device, transmitting the exercise record to the exercise management service system by the exercise recording device, and generating an exercise prescription according to the personal database and the exercise record by the exercise management service system.

The present invention further discloses an exercise management service system for a sports center including an exercise recording device and at least one exercise equipment. The system includes a communication unit for communicating with the exercise recording device to read an exercise record established by the exercise recording device, a processor coupled to the communication unit for establishing a personal database; and a storing unit coupled to the processor for being accessed by the processor to store the exercise record and the personal database, such that the processor generates an exercise prescription according to the personal database and the exercise record.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a sports center according to an embodiment of the present invention.

FIG. 2 is a flowchart of a process of providing exercise management service according to an embodiment of the present invention.

FIG. 3 is an input interface illustrating the self-indication and the sports preference.

FIG. 4 is a schematic diagram of an exercise prescription according to an embodiment of the present invention.

FIG. 5 is an input interface illustrating an equipment reservation according to an embodiment of the present invention.

FIG. 6 is a schematic diagram of an exercise record according to an embodiment of the present invention.

FIG. 7 is an interface illustrating a physical condition analyzing result according to an embodiment of the present invention.

### DETAILED DESCRIPTION

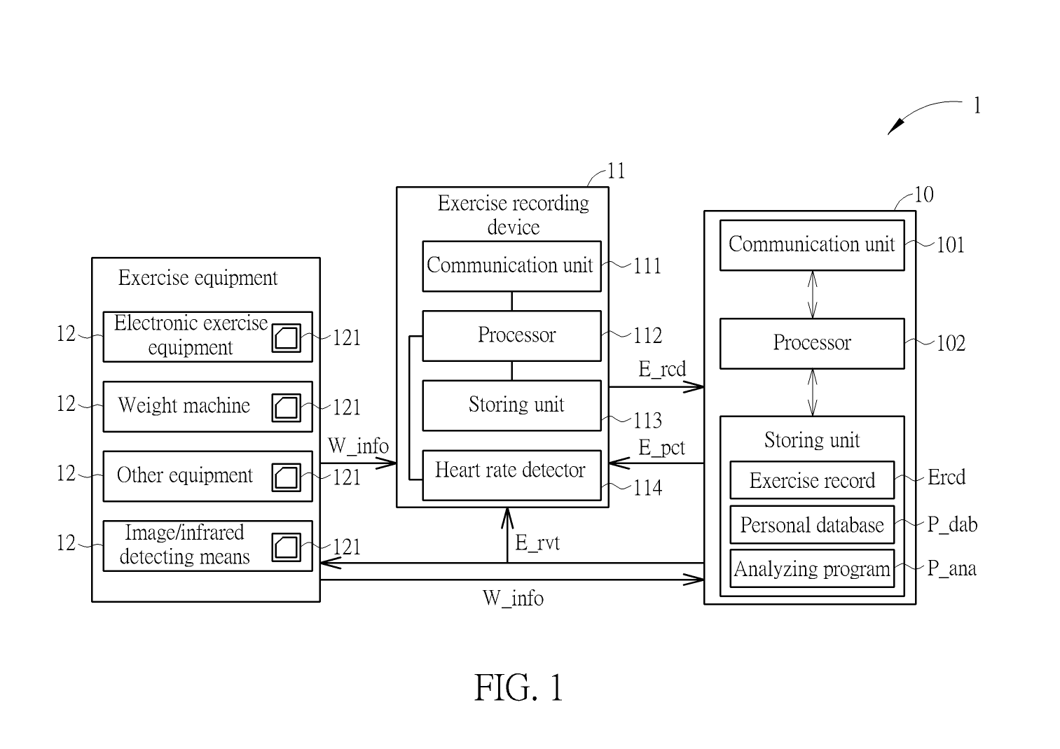

Please refer to FIG. 1, which is a functional block diagram of a sports center 1 according to an embodiment of the present invention. The sports center 1 includes an exercise management service system 10, an exercise recording device 11 and at least one exercise equipment 12. The exercise management service system 10 is used for providing services and management by electronic recording technologies, such that a personal database P_dab of a user may be established by the exercise management service system 10 once the user becomes a member of the sports center 1. The exercise management service system 10 may generate an exercise prescription E_pct according to the personal database P_dab, and transmit the exercise prescription E_pct to the exercise recording device 11, such that the user may follow an instruction of the exercise prescription E_pct. The exercise recording device 11 is used for establishing an exercise record E_rcd according to the exercise prescription E_pct when performing exercise, and the exercise recording device 11 may transmit the exercise record E_rcd to the exercise management service system 10 after the exercise is finished.

In detail, the exercise management service system 10 includes a communication unit 101, a processor 102 and a storing unit 103. The communication unit 101 is used for communicating with the exercise recording device 11 to read the exercise record E_rcd. The processor 102 is coupled to the communication unit 101 and used for establishing the personal database P_dab inputted by the user. The storing unit 103 is coupled to the processor 102, and used for being accessed by the processor 102 to store the exercise record E_rcd, the personal database P_dab and an analyzing program P_ana. Before the exercise record E_rcd is established, the processor 102 executes the analyzing program P_ana according to the personal database P_dab to generate the exercise prescription E_pct. After the exercise record E_rcd is established, the processor 102 executes the analyzing program P_ana according to the personal database P_dab and exercise record E_rcd to generate a new exercise prescription E_pct for the next time. As a result, the exercise management service system 10 may automatically modify contents of the exercise prescription E_pct to plan the exercise prescription E_pct for the user according to exercise record E_rcd. In addition, the exercise management service system 10 may schedule an equipment reservation E_rvt of the required exercise equipment 12 for the next time according to the exercise prescription E_pct. And the equipment reservation E_rvt may be transmitted to the exercise recording device 11 and the exercise equipment 12 by the communication unit 101 to prevent the exercise equipment from being occupied.

The exercise equipment 12 may be an electronic exercise equipment, a weight machine, and other types of exercise equipment such as an image detecting means or an infrared detecting means, wherein the image or infrared detecting means may be used for detecting body motions of the user to transmit a detecting result to the exercise recording device 11. And the exercise recording device 11 determines whether the user has performed an instructed exercise item, e.g. Yoga or Aerobics, according to the detecting result. Each of the exercise equipment 12 includes a communication unit 121 for transmitting an equipment information W_info to the exercise recording device 11 and the exercise management service system 10.

The exercise recording device 11 includes a communication unit 111, a processor 112, a storing unit 113 and a heart rate detector 114. The exercise recording device 11 may be a communication medium between the exercise management service system 10 and the exercise equipment 12, and the exercise recording device 11 may read the exercise prescription E_pct by the communication unit 111 to store in the storing unit 113. The processor 112 may guide the user to perform designated exercise items according to the exercise prescription E_pct. The exercise recording device 11 further reads the equipment information W_info of the exercise equipment 12 by the communication unit 111 communicating with the communication unit 121. In such a situation, the processor 112 may generate the exercise record E_rcd according to the equipment information W_info and the exercise prescription E_pct. Meanwhile, the exercise equipment 12 may transmit the equipment information W_info to the exercise management service system 10 by the communication unit 121 to instantly update information such as the exercise item that the user is performing to exercise management service system 10. As a result, the trainer may acquire a progress of the user from the exercise management service system 10. The heart rate detector 114 is used for detecting a heart rate of the user. Operations and circuit structures of the exercise recording device 11 are prior art, and are therefore omitted for the sake of brevity.

In short, under a structure of the sports center 1, the exercise management service system 10 may provide electronic recording and management technologies, such as establishing the personal database, scheduling the reservation for the exercise equipment and planning the proper exercise prescription for the user. Furthermore, by the exercise recording device 11 collecting the exercise record, this may prevent human errors made on paperwork and save manpower on routine recording work. In addition, the exercise management service system 10 may keep statistics on a number of used hours and times of the exercise equipment according to the scheduled reservation and the exercise record to accordingly arrange a maintenance and repairmen for the exercise equipment or arrange locations of the exercise equipment, which may improve an usage of the exercise equipment and save time for the user to search for available exercise equipment. After the user finishes the exercise, the exercise management service system 10 may modify the contents of the exercise prescription for the next time according to the exercise record in order to meet requirements of the user and reach a better exercise effect.

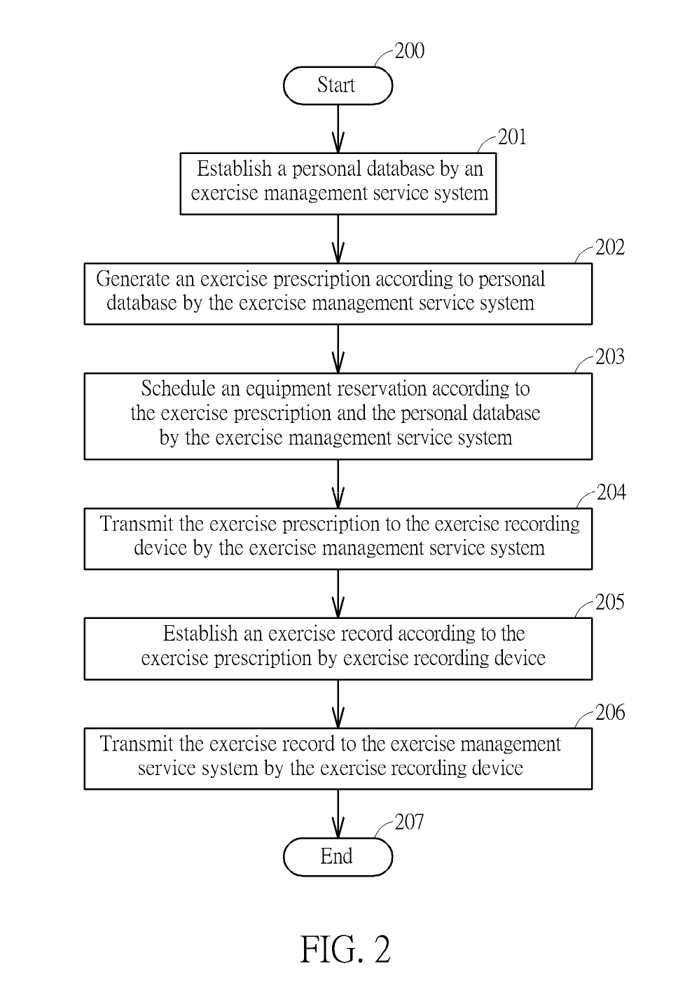

Please refer to FIG. 2, which is a flowchart of a process of providing exercise management service 20 according to an embodiment of the present invention. The process 20 may be utilized in the sports center 1 for providing electronic recording and management services. The process 20 includes the following steps:

Step 200: Start.

Step 201: Establish a personal database by an exercise management service system.

Step 202: Generate an exercise prescription according to personal database by the exercise management service system.

Step 203: Schedule an equipment reservation according to the exercise prescription and the personal database by the exercise management service system.

Step 204: Transmit the exercise prescription to the exercise recording device by the exercise management service system.

Step 205: Establish an exercise record according to the exercise prescription by exercise recording device.

Step 206: Transmit the exercise record to the exercise management service system by the exercise recording device.

Step 207: End.

In Step 201, the personal database P_dab at least includes a body indication, a sport preference, a self-indication, a renting record and an expenditure. The body indication at least includes a height, a body weight, a resting heart rate, a blood pressure and a maximum muscle duration. The sports preference at least includes team sports, water sports and track and field sports. The self-indication at least includes a fatigue indication and a sleep quality.

For example, the user provides personal data and performs a physical measurement and a physical fitness test to establish the personal database P_dab and a member account when joining the sports center 1. The personal data may include a name, an age, a gender, etc. The physical measurement may include a height, a body weight, a body mass index (BMI), a resting heart rate, a blood pressure, etc. The physical fitness test may include a maximum muscle strength, a maximum muscle endurance, a maximum heart rate, etc. And the user may further remark the sports preference, for example, the team sports may be any ball games such as basketball, soccer and badminton; the water sports may be swimming, diving and boating; and the track and field sports may be running, high jump, shot put, etc.

In addition, consider a situation that a body condition of the user varies day by day, the user may also remark the fatigue indication and the sleep quality before doing exercise, which allows the exercise management service system 10 to provide the proper exercise prescription E_pct according to the self-indication.

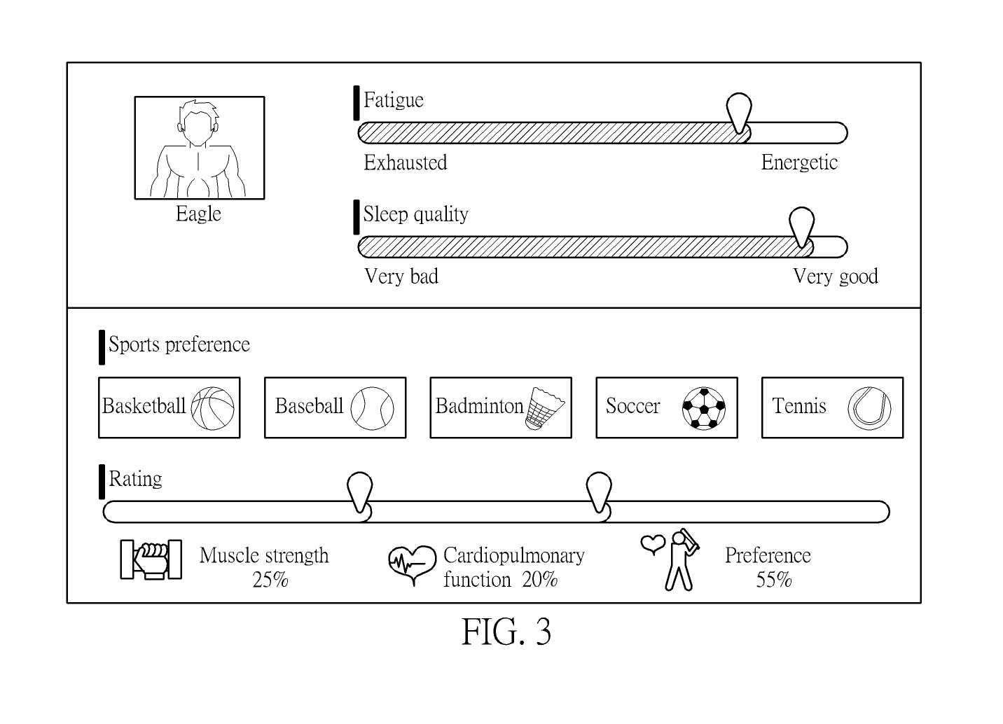

Specifically, please refer to FIG. 3, which is an input interface illustrating the self-indication and the sports preference. As shown in FIG. 3, the user may select from “Exhausted” to “Energetic” in a “Fatigue” indication bar, and select from “very bad” to “very good” in a “sleep quality” indication bar. The sports preference shows selections of basketball, baseball, badminton, soccer and tennis. Assume that the user selects badminton as his sports preference, the exercise management service system 10 may display ratings associated with playing badminton and the ratings may include 25% of the muscle strength, 20% of cardiopulmonary function, and 55% of preference.

In Step 202, the exercise management service system 10 generates the exercise prescription E_pct according to the personal database P_dab. Specifically, assume that the user wants to improve skills for playing badminton, and thus there is a need to build up muscle groups to enhance a swing power and a reacting speed for playing badminton by certain training programs. By taking the personal database P_dab in the analyzing program P_ana, the exercise management service system 10 may generate the exercise prescription E_pct for the user, and provides proper training programs to the user. If the user feels exhausted or has very bad sleep quality, the exercise management service system 10 may automatically decrease a difficulty of the exercise prescription E_pct, e.g. decrease a number of repetitions and a weight for weight training, or adjust exercise items in the exercise prescription E_pct, e.g. increase items for aerobics or decrease items for weight training. On the other hand, if the user feels energetic and has very good sleep quality, the exercise management service system 10 may automatically increase the difficulty of the exercise prescription E_pct, e.g. increase the number of repetitions and the weight for weight training, or decrease items for aerobics or increase items for weight training.

Noticeably, items in the exercise prescription E_pct are arranged according to a specific order and a duration for improving the exercise effect and avoiding sports injuries. Specifically, when a human body is turning from inactive to active, warm-up helps the body transferring blood to muscles to increase both of body temperature and oxygen-carrying capacity of blood, which protects the heart and blood vessels from sudden pressure variation to reduce a risk of sports injuries and improve an effect for the mainly-played sports. Moreover, the warm-up should be associated with the mainly-played sports, for example, the warm-up for running shall be jogging or fast walking, and the warm-up for strength training shall be aerobics. And a rest time between two exercise items is also required to help recovering muscles avoid fatigue and prevent sports injuries. When the human body turns from active to inactive after the sports is finished, cool-down may help the body with clearing metabolite, transferring blood to organs, and reducing body temperature.

Therefore, in order to cultivate a correct exercise concept for the user for improving the exercise effect and avoiding sports injuries, the exercise prescription E_pct is established according to an order of “Warm-up”, “First exercise”, “Rest”, “Second exercise” and “Cool-down” and those corresponding durations. The “Rest” item may be arranged between two or more exercise items and indicated by the exercise recording device 11 to instruct the user to rest.

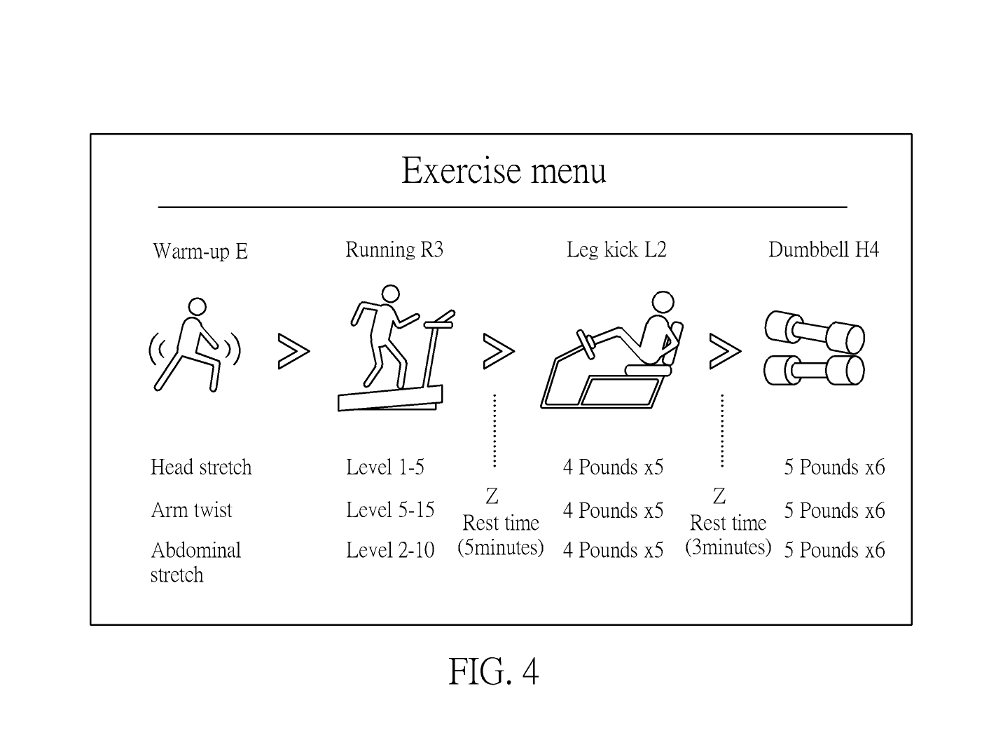

Please refer to FIG. 4, which is a schematic diagram of an exercise prescription according to an embodiment of the present invention. As shown in FIG. 4, the exercise items included in the exercise prescription E_pct are warm-up, running, leg kick and dumbbell. And a duration for warm-up is five minutes; a rest time between running and leg kick is five minutes; and a rest time between leg kick and dumbbell is three minutes. Therefore, the exercise prescription E_pct is established not only for building up the muscle groups of the user, but also improving the exercise effect and avoiding sports injuries.

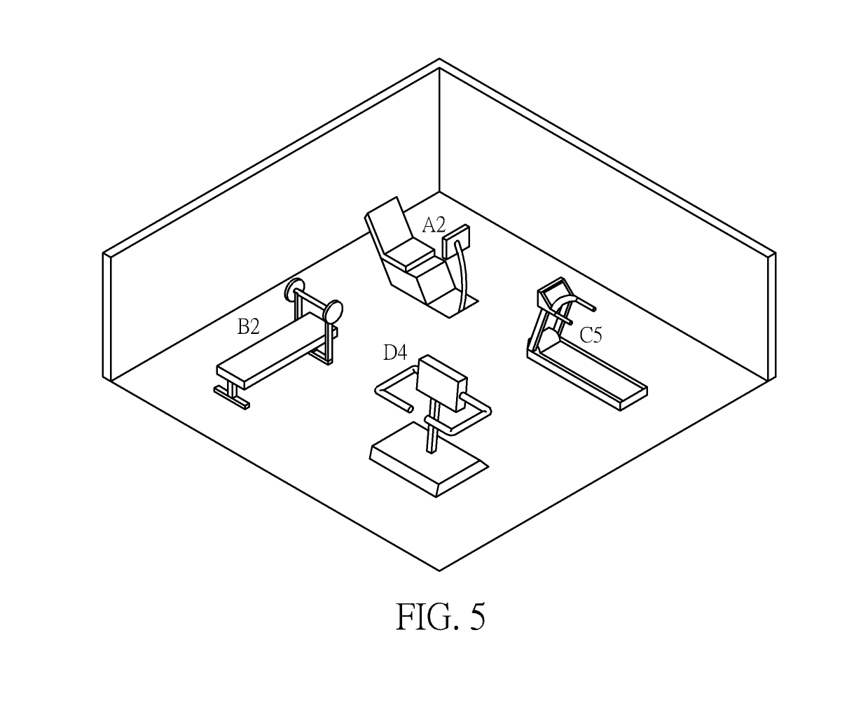

In Step 203, the exercise management service system 10 generates the equipment reservation E_rvt according to the exercise prescription E_pct and the personal database P_dab. Please refer to FIG. 5, which is an input interface illustrating an equipment reservation according to an embodiment of the present invention. As shown in FIG. 5, each of the exercise equipment has its own machine codes, e.g. B2, A2, C5 and D4, which indicates locations and which exercise equipment is reserved. In other words, the exercise management service system 10 may reserve the exercise equipment 12 for the user, which prevents the exercise equipment 12 from being occupied and is also beneficial for equipment management of the sports center 1.

Moreover, if the user rents a locker, towels, and the exercise recording device 11, or if the user has any expenditure in the sports center 1, the personal database P_dab may record a renting record and the expenditure, which is also beneficial for equipment management of the sports center 1.

As a result, by gathering information as above mentioned to establish the personal database P_dab, the exercise management service system 10 may provide electronic recording technologies to automatically generate the proper exercise prescription E_pct for the user and help the user to cultivate the correct exercise concept. In addition, gathering the renting record, the expenditure and the equipment reservation E_rvt may be beneficial for equipment management of the sports center 1.

In Step 204 and Step 205, the exercise management service system 10 transmits the exercise prescription E_pct to the exercise recording device 11 by the communication unit 101. And the exercise recording device 11 instructs the user to perform the exercise items according to exercise prescription E_pct.

When performing the “Warm-up”, “Rest” and “Cool-down” items, the exercise prescription E_pct may indicate a warm-up, a cool-down, a heart rate and a rest time to instruct the user to perform warm-up before an intensive exercise and instruct the user to rest or perform cool-down after the intensive exercise, which protects the user from sports injuries.

The user is required to finish the warm-up to activate the exercise recording device 11 to go on to the following instruction and recording.

In a first embodiment, the exercise recording device 11 may utilize the heart rate detector 114 to detect a heart rate of the user to determine whether the user has performed warm-up. Assume a treadmill is the instructed exercise equipment for warm-up and a movement for warm-up is jogging. The exercise recording device 11 may determine the user has performed the warm-up if the heart rate detected by the heart rate detector 114 is greater than a threshold. On the contrary, the exercise recording device 11 may determine the user has not performed the warm-up if the heart rate detected by the heart rate detector 114 is smaller than the threshold, and the exercise recording device 11 does not record the exercise record E_rcd for the warm-up. In other words, the exercise recording device 11 does not establish the exercise record E_rcd if the heart rate of the user is smaller than the heart rate, i.e. the threshold, indicated by the exercise prescription when the user is performing the warm-up.

In a second embodiment, which assumes that the exercise equipment for the warm-up is a billboard illustrating stretch poses, and each of the stretch poses corresponds to a communication unit for transmitting the equipment information W_info. The exercise recording device 11 may read the equipment information W_info by the communication unit 111 once a stretch pose is performed by the user, and the exercise recording device 11 determines the user has finished the warm-up once all the equipment information W_info corresponding to all the stretch poses are read. In another embodiment, the stretch poses may correspond to a sensing unit, e.g. QR code, and the exercise recording device 11 determines the user has finished the warm-up once all the QR code corresponding to all the stretch poses are read.

In a third embodiment, since an image or infrared detecting means may detect body motions of the user, the image or infrared detecting means may transmit a detecting result to the exercise recording device 11 once the user performs the body motions instructed by the exercise recording device 11 or instructed by the billboard in the second embodiment, and the exercise recording device 11 then determines whether the user has finished the warm-up accordingly.

In the above three embodiments, the exercise recording device 11 may emit a notification light to inform the user that the “Warm-up” item is finished and will go on to the following instruction and recording. For example, the notification light may be red to indicate the “Warm-up” item is not finished, and be blue to indicate the “Warm-up” item is finished.

The user is required to rest after an intensive exercise is finished to activate the exercise recording device 11 to go on to the following instruction and recording.

In a first embodiment, the exercise recording device 11 times a rest time by a timer. The exercise recording device 11 may determine the user rests sufficiently when the rest time is due and goes on the following instruction and recording.

In a second embodiment, the exercise recording device 11 determines whether the user rests sufficiently by the heart rate detector 114 to detect whether the heart rate of the user is lower than a threshold. The exercise recording device 11 determines the user rests sufficiently if the heart rate of the user is smaller than the threshold. On the other hand, the exercise recording device 11 determines the user does not rest sufficiently if the heart rate of the user is greater than the threshold, and the exercise recording device 11 does not record the exercise record E_rcd. In other words, the exercise recording device 11 does not establish the exercise record E_rcd if the heart rate of the user is greater than the heart rate indicated by the exercise prescription E_pct during the rest time.

In the above two embodiments, the exercise recording device 11 may emit a notification light to inform the user that the “Rest” item is finished and goes on the following instruction and recording. For example, the notification light may be red to indicate the “Rest” item is not finished, and be blue to indicate the “Rest” item is finished.

The exercise record E_rcd corresponds to the exercise prescription E_pct, and the exercise record E_rcd at least includes a movement, a number of repetition, a duration, a type of equipment, a machine code, a weight, a distance, a slope, a number of calories burned and a muscle group, which allows the exercise recording device 11 to instruct the user to use the instructed the exercise equipment 12 and perform the exercise items. The exercise recording device 11 may read the equipment information W_info of the exercise equipment 12 to establish the exercise record E_rcd accordingly.

For example, if the exercise equipment 12 is a weight machine, the equipment information W_info indicates a type of equipment, a machine code, a muscle group, a movement and a weight. If the exercise equipment 12 is an electronic exercise equipment, e.g. a treadmill, a bicycle, and cross trainer, the equipment information W_info indicates a type of equipment, a machine code, a distance, a slope, a duration, a number of calories burned, a muscle group, and a duration. Since the electronic exercise equipment may have a function of calculating distance, slope, number of calories burned and duration, the exercise recording device 11 may directly read the equipment information W_info recorded by the electronic exercise equipment to establish the exercise record E_rcd. If the exercise equipment 12 is another type of exercise equipment, e.g. a weight bench, and a rehab equipment, the equipment information W_info indicates a type of equipment, a machine code, a muscle group, and a movement. Or, if the exercise prescription E_pct indicates an exercise item which is performed without any equipment, e.g. Yoga and Aerobics, the image or infrared detecting means may detect the body motions of the user to generate a detecting result to the exercise recording device 11.

The user is required to perform the “Cool-down” after all the other exercise items are finished to activate the exercise recording device 11 to finish the exercise record E_rcd.

After the user finishes the “Cool-down” item, the exercise recording device 11 may detect the heart rate of the user by the heart rate detector 114 to determine whether the user finishes the “Cool-down” item. The exercise recording device 11 determines the user does not finish the “Cool-down” item if the heart rate of the user is greater than a threshold, and the exercise recording device 11 does not finish the exercise record E_rcd. In other words, the exercise recording device 11 does not finish the exercise record E_rcd if the heart rate of the user is greater than the heart rate indicated by the exercise prescription E_pct when performing the “Cool-down” item.

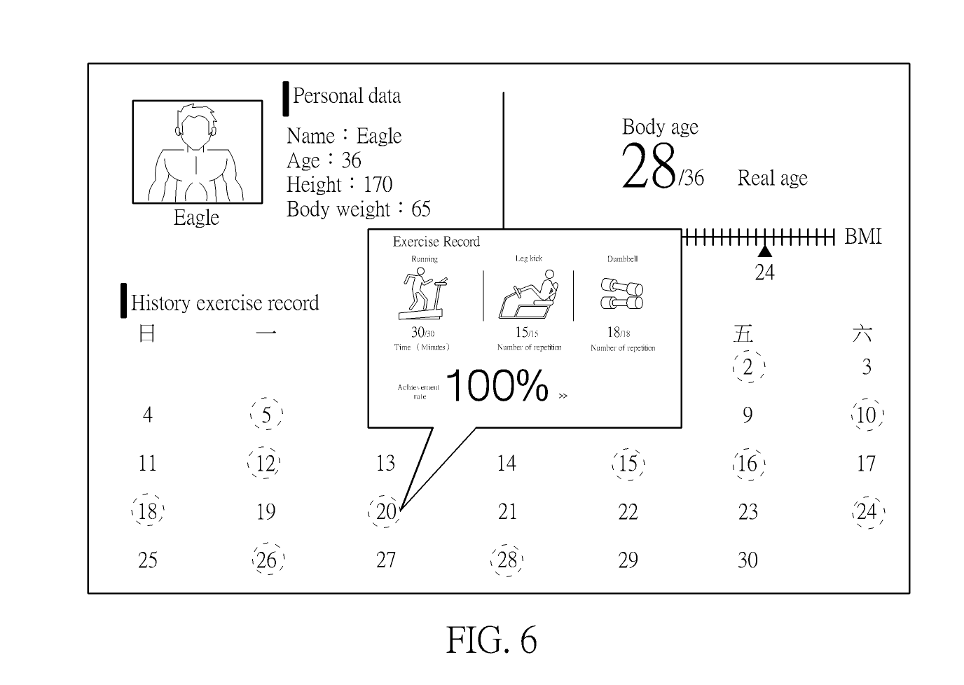

In Step 206, after the user finishes all the exercise items indicated by the exercise prescription E_pct, the exercise recording device 11 finishes the exercise record E_rcd at the same time. When the user returns the exercise recording device 11, the exercise recording device 11 may transmit the exercise record E_rcd to the exercise management service system 10 by the communication unit 111 to store the exercise record E_rcd in the personal database P_dab. The exercise recording device 11 may then clean the exercise record E_rcd for the next user. Please refer to FIG. 6, which is a schematic diagram of an exercise record according to an embodiment of the present invention. As shown in FIG. 6, the exercise record includes the personal data of the user (i.e. name, age, height, body weight, body age and BMI), dates when the user came to the sports center 1 (which are remarked by dashed circles) and the exercise records corresponding to those dates.

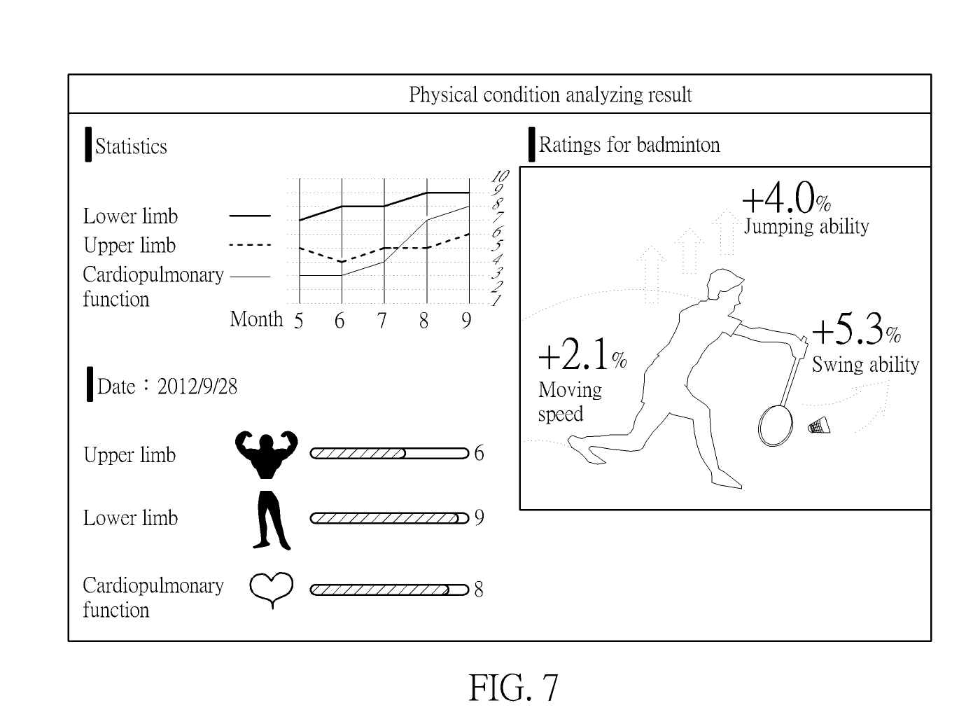

Please refer to FIG. 7, which is an interface illustrating a physical condition analyzing result according to an embodiment of the present invention. As shown in FIG. 7, the interface displays physical statistics of the user including a muscle strength indication (lower and upper limb muscles) and a cardiopulmonary function, a today's muscle strength and a comparison chart between the cardiopulmonary function and a target. The exercise management service system 10 may take the exercise record E_rcd into the analyzing program P_ana to calculate numerical ratings for reference, which makes the exercise effect quantified. For example, in order to improve skills for playing badminton, a moving speed increases 2.1%, a jumping ability increases 4% and a swing power increases 5.3% after the user finishes the exercise prescription E_pct.

Therefore, the personal database P_dab may be established in a form of numerical data to store in the storing unit 103 of the exercise management service system 10. When the user leaves the sports center 1, the user may connect to the exercise management service system 10 by the Internet to login to the member account to modify the personal data to update the personal database P_dab, or review the exercise record. And the exercise management service system 10 may have a function of social sharing and holding competitions to share the exercise record to other users, which makes performing exercise more interesting to provide a motive for continuing exercise.

To sum up, by the process of providing exercise management service 20, the exercise management service system 10 may provide electronic recording and management technologies, such as establishing the personal database, scheduling the reservation for the exercise equipment and planning the proper exercise prescription for the user. In order to cultivate a correct exercise concept for the user for improving the exercise effect and avoiding sports injuries, the exercise prescription is established according to a specific order of corresponding durations. Furthermore, by the exercise recording device 11 collecting the exercise record this may prevent human errors made on paperwork and save manpower on routine recording work. In addition, the exercise management service system 10 may keep statistics on a number of used hours and times of the exercise equipment according to the scheduled reservation and the exercise record to accordingly arrange a maintenance and repairmen for the exercise equipment or arrange locations of the exercise equipment, which may improve an usage of the exercise equipment and save time for the user to search for available exercise equipment. After the user finishes the exercise, the exercise management service system 10 may modify the contents of the exercise prescription for the next time according to the exercise record in order to meet requirements of the user and reach a better exercise effect.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of providing exercise management service for a sports center, wherein the sports center includes an exercise management service system, an exercise recording device and at least one exercise equipment, comprising:
establishing a personal database by the exercise management service system;
establishing an exercise record by the exercise recording device;
transmitting the exercise record to the exercise management service system by the exercise recording device; and
generating an exercise prescription according to the personal database and the exercise record by the exercise management service system.

2. The method of claim 1, wherein establishing the exercise record by the exercise recording device comprises:
establishing the exercise record according to equipment information of the at least one exercise equipment.

3. The method of claim 2, wherein the exercise equipment is an electronic exercise equipment, a weight machine, an image detecting means, or an infrared detecting means.

4. The method of claim 3, wherein the equipment information indicates a type of equipment, a machine code, a distance, a slope, a number of calories burned, a muscle group and a duration if the at least one exercise equipment is the electronic exercise equipment.

5. The method of claim 3, wherein the equipment information indicates a type of equipment, a machine code, a muscle group, a movement and a weight if the at least one exercise equipment is the weight machine.

6. The method of claim 2, wherein the exercise record corresponds to the exercise prescription, and the exercise prescription indicates a movement, a number of repetition, a duration, a type of equipment, a machine code, a weight, a distance, a slope, a number of calories burned and a muscle group.

7. The method of claim 2, wherein the exercise record corresponds to the exercise prescription, and the exercise prescription indicates a warm-up, cool-down, a heart rate and a rest time.

8. The method of claim 7, wherein the exercise recording device detects a heart rate of a user by a heart rate detector, and establishing the exercise record by the exercise recording device comprises:
not establishing the exercise record if the heart rate of the user is smaller than the heart rate indicated by the exercise prescription when the user is performing the warm-up;
not establishing the exercise record if the heart rate of the user is greater than the heart rate indicated by the exercise prescription during the rest time; and
not establishing the exercise record if the heart rate of the user is greater than the heart rate indicated by the exercise prescription when the user is performing the cool-down.

9. The method of claim 1, wherein the personal database at least comprises a body indication, a sport preference, a self-indication, a renting record and an expenditure.

10. The method of claim 9, wherein the body indication at least comprises a height, a body weight, a blood pressure, a quiet heart rate, and a maximum muscle endurance.

11. The method of claim 9, wherein the sport preference at least comprises team sports, water sports and track and field sports.

12. The method of claim 9, wherein the self-indication at least comprises a fatigue and a sleep quality.

13. The method of claim 9, wherein generating an exercise prescription according to the personal database and the exercise record by the exercise management service system comprises:
executing an analyzing program according to the body indication and the sport preference to generate the exercise prescription.

14. The method of claim 1, further comprising:
transmitting the exercise prescription to the exercise recording device by the exercise management service system.

15. The method of claim 1, further comprising:
scheduling an equipment appointment according to the exercise prescription and the personal database by the exercise management service system;
transmitting the equipment appointment to the exercise recording device and the at least one exercise equipment by the exercise management service system.

16. An exercise management service system for a sports center including an exercise recording device and at least one exercise equipment, comprising:
a communication unit for communicating with the exercise recording device to read an exercise record established by the exercise recording device;
a processor coupled to the communication unit for establishing a personal database; and
a storage coupled to the processor for being accessed by the processor to store the exercise record and the personal database, such that the processor generates an exercise prescription according to the personal database and the exercise record.

17. The system of claim 16, wherein the exercise recording device establishes the exercise record according to equipment information of the at least one exercise equipment.

18. The system of claim 17, wherein the exercise equipment is an electronic exercise equipment, a weight machine, an image detecting means, or an infrared detecting means.

19. The system of claim 18, wherein the equipment information indicates a type of equipment, a machine code, a distance, a slope, a number of calories burned, a muscle group and a duration if the at least one exercise equipment is the electronic exercise equipment.

20. The system of claim 18, wherein the equipment information indicates a type of equipment, a machine code, a muscle group, a movement and a weight if the at least one exercise equipment is the weight machine.

21. The system of claim 17, wherein the exercise record corresponds to the exercise prescription, and the exercise prescription indicates a movement, a number of repetition, a duration, a type of equipment, a machine code, a weight, a distance, a slope, a number of calories burned and a muscle group.

22. The system of claim 17, wherein the exercise record corresponds to the exercise prescription, and the exercise prescription indicates a warm-up, cool-down, a heart rate and a rest time.

23. The system of claim 22, wherein the exercise recording device includes a heart rate detector for detecting a heart rate of a user, the exercise recording device does not establish the exercise record if the heart rate of the user is smaller than the heart rate indicated by the exercise prescription when the user is performing the warm-up; the exercise recording device does not establish the exercise record if the heart rate of the user is greater than the heart rate indicated by the exercise prescription during the rest time; and the exercise recording device does not establish the exercise record if the heart rate of the user is greater than the heart rate indicated by the exercise prescription when the user is performing the cool-down.

24. The system of claim 16, wherein the personal database at least comprises a body indication, a sport preference, a self-indication, a renting record and an expenditure.

25. The system of claim 24, wherein the body indication at least comprises a height, a body weight, a blood pressure, a quiet heart rate, and a maximum muscle endurance.

26. The system of claim 24, wherein the sport preference at least comprises team sports, water sports and track and field sports.

27. The system of claim 24, wherein the self-indication at least comprises a fatigue and a sleep quality.

28. The system of claim 24, wherein the processor executes an analyzing program according to the body indication and the sport preference to generate the exercise prescription.

29. The system of claim 16, wherein the communication unit transmits the exercise prescription to the exercise recording device.

30. The system of claim 16, wherein the processor schedules an equipment appointment according to the exercise prescription and the personal database by the exercise management service system, such that the communication unit transmits the equipment appointment to the exercise recording device and the at least one exercise equipment.
